(19) United States
(12) Patent Application Publication
(10) Pub. No.: US 2026/0356291 A1
(43) Pub. Date: Nov. 12, 2026

(54) PARKING ASSISTANCE METHOD, PARKING ASSISTANCE APPARATUS, AND PARKING ASSISTANCE SYSTEM INCLUDING THE SAME

(71) Applicant: HL Klemove Corp., Incheon (KR)

(72) Inventor: Ji Won KANG, Incheon (KR)

(73) Assignee: HL Klemove Corp., Incheon (KR)

(21) Appl. No.: 19/569,316

(22) Filed: Mar. 17, 2026

(30) Foreign Application Priority Data
May 8, 2025 (KR) 10-2025-0059899

(51) Int. Cl. B60R 1/26; B60Q 1/50; G06T 7/80; G06V 20/58

(52) U.S. Cl. CPC B60R 1/26; B60Q 1/50; G06T 7/80; B60R 2300/307; B60R 2300/806; G06T 2207/30261; G06V 20/58

(57) ABSTRACT

Provided is a parking assistance apparatus for improving the accuracy of obstacle distance determination in a parking assistance system for recognizing a rear obstacle of a vehicle. The parking assistance apparatus includes a ground inclination estimator configured to estimate a ground inclination behind a vehicle, and an obstacle distance error corrector configured to correct distance information to the recognized rear obstacle of the vehicle according to the estimated ground inclination.

### CROSS-REFERENCE TO RELATED APPLICATIONS

The present application is based upon and claims the benefit of priority to Korean Patent Application No. 10-2025-0059899 filed on May 8, 2025, the contents of each of which are incorporated herein by reference in their entirety.

### TECHNICAL FIELD

The present disclosure relates to a parking assistance system and, more particularly, to a parking assistance apparatus, a parking assistance system including the same, and a method thereof, which estimate an inclination of a ground surface behind a vehicle using a camera installed at a rear of the vehicle, thereby improving accuracy in determining a distance to an obstacle.

### BACKGROUND

A conventional image-based vehicle parking assistance system provides information on the presence of an obstacle and distance information based on an image captured by a rear camera of a vehicle, but it is difficult to accurate distance measurement is difficult due to tilting of the vehicle or inclination of a ground surface. In particular, when the ground surface is inclined, there is a high risk that an accident may occur due to an incorrect determination of a distance to the obstacle. In addition, when a large number of passengers are on board or heavy cargo is loaded in the vehicle, the vehicle itself may be tilted, which may also reduce accuracy in calculating an obstacle distance in the parking assistance system.

### SUMMARY

The present disclosure has been made to solve the above-described problems, and an object of the present disclosure is to improve accuracy of a parking assistance system by estimating an inclination of a ground surface in real time through a rear camera of a vehicle and correcting distance information to an obstacle based on the inclination. That is, the present disclosure provides a parking assistance apparatus, a parking assistance system including the same, and a method thereof, which enable more accurate obstacle distance recognition even when the vehicle itself is tilted.

Technical objects to be achieved by the present disclosure are not limited to the aforementioned technical objects, and other technical objects not described above may be evidently understood by a person having ordinary skill in the art from the following description.

In an aspect, a parking assistance apparatus for improving the accuracy of obstacle distance determination in a parking assistance system for recognizing a rear obstacle of a vehicle is provided. The parking assistance apparatus includes a ground inclination estimator configured to estimate a ground inclination behind a vehicle, and an obstacle distance error corrector configured to correct distance information to a rear obstacle of the vehicle according to the estimated ground inclination.

The ground inclination estimator may be configured to estimate the ground inclination based on a rear image captured by a rear camera of the vehicle.

The rear image may be captured to include a real-time guide image projected onto a ground surface behind the vehicle by a guide lamp installed at a rear of the vehicle.

The parking assistance apparatus may further include a projected guide image extractor configured to extract data related to the real-time guide image from the rear image.

The parking assistance apparatus may further include a reference guide image manager configured to generate and manage, as a reference guide image, a guide image projected by the guide lamp onto a flat ground surface that is not inclined with respect to the vehicle.

The ground inclination estimator may be configured to estimate the ground inclination by comparing data related to the real-time guide image with data related to the reference guide image.

The ground inclination estimator may be configured to estimate the ground inclination based on a displacement difference between a specific real-time point within the real-time guide image and a specific reference point within the reference guide image corresponding to the specific real-time point.

The real-time guide image and the reference guide image may include first and second real-time guide images and first and second reference guide images, respectively, which are spaced apart from each other in a lateral direction of the vehicle, and the ground inclination estimator may be configured to estimate a longitudinal ground inclination of the vehicle based on a first displacement difference between a first real-time point in the first real-time guide image and a first reference point in the first reference guide image, and a second displacement difference between a second real-time point in the second real-time guide image and a second reference point in the second reference guide image, and to estimate a lateral ground inclination based on a difference value between the first displacement difference and the second displacement difference.

Each of the first and second displacement differences may be a vector value, the longitudinal ground inclination may be estimated based on an average vector value of the first and second displacement differences, and the lateral ground inclination is estimated based on a difference vector value of the first and second displacement differences.

In another aspect, a parking assistance system includes a guide lamp configured to project a guide image onto a ground surface behind a vehicle, a camera configured to acquire an image of an imaging area including the guide image projected by the guide lamp, and a parking assistance device configured to determine the presence of and a distance to an obstacle located behind the vehicle, and the parking assistance device includes a ground inclination estimator configured to estimate a ground inclination behind the vehicle, and an obstacle distance error corrector configured to correct distance information to the recognized rear obstacle of the vehicle according to the estimated ground inclination.

The parking assistance system may further include a display configured to display an image acquired in conjunction with the camera.

The parking assistance system may further include a distance sensor implemented by at least one of an ultrasonic proximity sensor, a radar, and a lidar; and the obstacle distance error corrector may be configured to correct distance information to the rear obstacle of the vehicle by additionally considering an obstacle recognition distance sensed by the distance sensor.

In a further aspect, a parking assistance method for improving the accuracy of obstacle distance determination in a parking assistance system for recognizing a rear obstacle of a vehicle is provided. The parking assistance method includes estimating a ground inclination behind a vehicle based on a rear image captured by a rear camera of the vehicle, and correcting distance information to a recognized obstacle located behind the vehicle according to the estimated ground inclination.

In the estimating of the inclination, the rear image may be captured to include a real-time guide image projected onto a ground surface behind the vehicle by a guide lamp installed at a rear of the vehicle.

The estimating of the inclination may include extracting data related to the real-time guide image from the rear image, and comparing data of the real-time guide image with data of a reference guide image projected onto a flat ground surface having no inclination.

The parking assistance method may further include determining whether calibration of the rear camera of the vehicle has been performed, and when the calibration has not been performed, the estimating of the inclination and the correcting of the distance information to the obstacle may not be performed.

The calibration may be an inline calibration performed in a stopped state of the vehicle using a pattern installed on a ground surface; or a driving calibration performed during driving of the vehicle.

The inline calibration may be performed using a separate installation pattern on a flat ground surface prepared for the inline calibration, and the driving calibration may be performed using a feature point on a ground surface behind the vehicle captured by the rear camera of the vehicle during driving of the vehicle.

When the inline calibration is performed, the reference guide image may be extracted from an image of the inline calibration, and when the driving calibration is performed, the reference guide image may be estimated based on design values of the guide lamp and the vehicle rear camera.

The parking assistance method may further include determining whether an additional tolerance compensation has been performed after the reference guide image has been extracted or estimated, and when the additional tolerance compensation has been performed, determining whether a value of the additional tolerance compensation is within a preset error range. When the value of the additional tolerance compensation is not within the preset error range, comparing data of the real-time guide image with data of the reference guide image may not be performed.

### ADVANTAGEOUS EFFECTS

According to embodiments of the present disclosure, the accuracy of a parking assistance system can be significantly improved by correcting a distance error to an obstacle that may occur due to an inclination of a ground surface behind a vehicle and tilting of the vehicle. This can reduce the risk of accidents that may occur during reverse parking, and can assist or support safe parking.

Effects of the present disclosure are not limited to the above-mentioned effects, and other effects that are not mentioned above will be clearly understood by those skilled in the art from the following description.

### BRIEF DESCRIPTION OF THE DRAWINGS

FIG. 1 is a diagram schematically illustrating a parking assistance system including a parking assistance apparatus according to some embodiments of the present disclosure.

FIGS. 2 to 4 are exemplary diagrams for explaining a ground inclination estimation method of a parking assistance apparatus according to some embodiments of the present disclosure.

FIG. 5 is an exemplary flowchart for explaining the ground inclination estimation method according to some embodiments of the present disclosure.

FIG. 6 is an exemplary diagram for explaining a guide image captured by a rear camera after additional tolerance compensation according to some embodiments of the present disclosure.

FIG. 7 is an exemplary configuration diagram of a vehicle to which a parking assistance system according to some embodiments of the present disclosure is applied.

FIG. 8 is an exemplary configuration diagram illustrating a computing device.

### DETAILED DESCRIPTION

Hereinafter, the preferred embodiments of the present disclosure will be described in detail with reference to the accompanying drawings. The advantages and features of the present disclosure and the method for achieving them will be easily understood from the following embodiments in conjunction with the accompanying drawings. However, the technical idea of the present disclosure may be embodied in different forms without being limited to the embodiments set forth hereinbelow. Rather, the following embodiments are provided to make the present disclosure thorough and complete and to sufficiently convey the spirit of the present disclosure to those skilled in the art, and the technical idea of the present disclosure is defined solely by the claims.

It should be noted that the same reference numerals are used throughout the drawings to designate the same components. In addition, in describing the present disclosure, when it is determined that the detailed description of the known art related to the present disclosure may obscure the gist of the present disclosure, the detailed description thereof will be omitted.

Unless otherwise defined, all terms including technical and scientific terms used herein have the same meaning as commonly understood by one of ordinary skill in the art to which the present disclosure belongs. Further, terms defined in commonly used dictionaries will not be interpreted in an idealized or overly formal sense unless expressly so defined herein. Terms used herein are for the purpose of describing embodiments only and are not intended to be limiting. Herein, the singular forms are intended to include the plural forms as well, unless the context clearly indicates otherwise.

The terms “first”, “second”, “A”, “B”, “(a)”, “(b)”, etc. may be used herein to describe various components. These terms are only used to distinguish one component from another component, and the use of the terms does not limit the nature, sequence, or order of the components. When a component is described as being “connected,” “coupled,” or “joined” to another component, it should be understood that the component may be directly connected or coupled to the other component, but that another component may also be “connected,” “coupled,” or “joined” between the components.

The terms “comprises” and/or “comprising” when used herein do not preclude the presence or addition of one or more other components, steps, operations and/or elements.

As used herein, the term “vehicle” may be defined as a transportation means that travels on a road or a rail. That is, the vehicle may include an automobile, a train, and a motorcycle. In addition, the vehicle may include an internal combustion engine vehicle having an engine as a power source, a hybrid vehicle having an engine and an electric motor as a power source, and an electric vehicle having an electric motor as a power source. Furthermore, the vehicle may be a privately owned vehicle or a shared vehicle.

Hereinafter, various embodiments of the present disclosure will be described in detail with reference to the accompanying drawings.

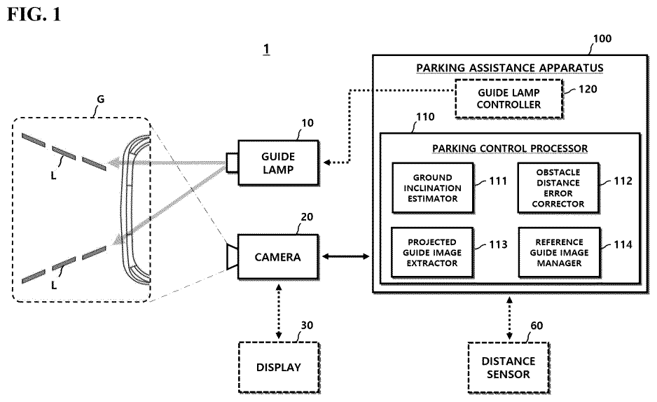

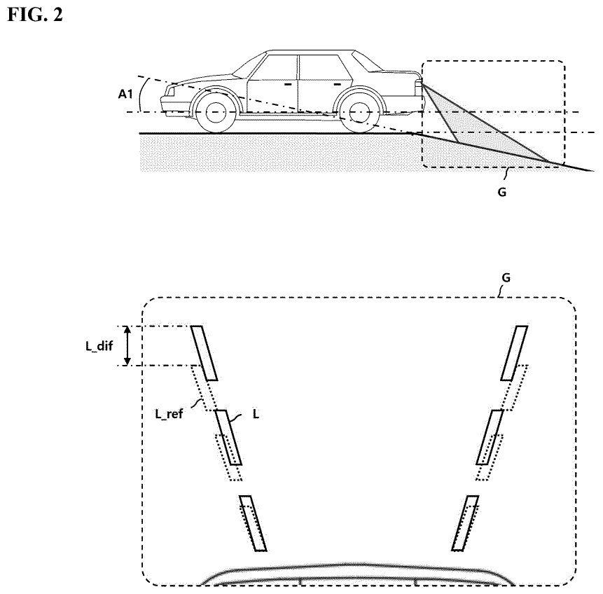

FIG. 1 is a diagram schematically illustrating a parking assistance system including a parking assistance apparatus according to some embodiments of the present disclosure, and FIGS. 2 to 4 are exemplary diagrams for explaining a ground inclination estimation method of a parking assistance apparatus according to some embodiments of the present disclosure.

Referring to FIGS. 1 to 4, a parking assistance system 1 may include a parking assistance apparatus 100 for improving accuracy in determining a distance to a rear obstacle of a vehicle, a guide lamp 10 configured to project a guide image onto a ground surface behind the vehicle, a camera 20 configured to acquire an image of an imaging area including the guide image projected by the guide lamp 10, and a display 30 configured to display the acquired image in cooperation with the camera 20.

The parking assistance system 1 of the present disclosure is based on vision-based obstacle recognition using at least one camera installed in the vehicle, but as illustrated in FIG. 1, the parking assistance system 1 may further include a distance sensor 60 implemented using an ultrasonic proximity sensor, radar, and lidar, and may provide a function of improving accuracy in determining the distance to the rear obstacle by comprehensively considering a vision-based obstacle recognition result and an obstacle recognition result based on the distance sensor 60.

The parking assistance apparatus 100 may include a parking control processor 110. The parking control processor 110 may be configured to include a ground inclination estimator 111 configured to estimate an inclination of a ground surface behind the vehicle, and an obstacle distance error corrector 112 configured to correct distance information to the recognized rear obstacle of the vehicle according to the estimated ground inclination.

The ground inclination estimator 111 may estimate the ground inclination based on a rear image G captured by a rear camera of the vehicle.

The rear image G refers to an image captured to include a real-time guide image L projected onto the ground surface behind the vehicle by the guide lamp 10 installed at the rear of the vehicle.

In some embodiments, the parking control processor 110 may include a projected guide image extractor 113 configured to extract data related to the real-time guide image L from the rear image G, and a reference guide image manager 114 configured to generate and manage a guide image projected by the guide lamp 10 onto a flat ground surface that is not inclined with respect to the vehicle as a reference guide image L_ref.

The ground inclination estimator 111 is characterized in that it estimates the ground inclination by comparing data of the real-time guide image L with data of the reference guide image L_ref.

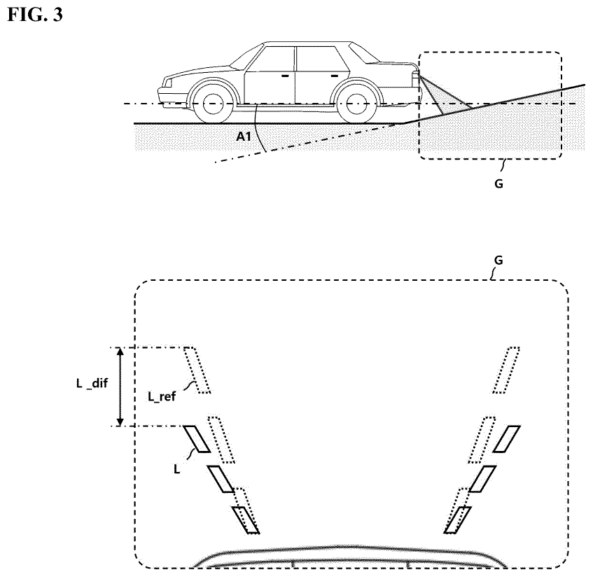

In some embodiments, as illustrated in FIGS. 2 and 3, the ground inclination estimator 111 may estimate the ground inclination based on a displacement difference L_dif between a specific real-time point within the real-time guide image L and a specific reference point within the reference guide image L_ref corresponding to the specific real-time point.

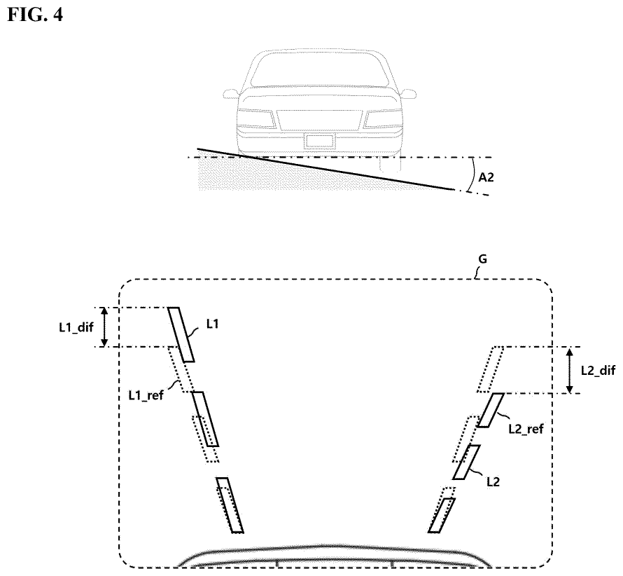

As a more specific example, as illustrated in FIG. 4, the real-time guide image L and the reference guide image L_ref include respectively first and second real-time guide images L1 and L2 and first and second reference guide images L1_ref and L2_ref, which are spaced apart from each other in a lateral direction of the vehicle. The ground inclination estimator 111 may estimate a longitudinal ground inclination A1 of the vehicle, with reference to FIGS. 2 to 3, based on a first displacement difference L1_dif between a first real-time point in the first real-time guide image L1 and a first reference point in the first reference guide image L1_ref, and a second displacement difference L2_dif between a second real-time point in the second real-time guide image L2 and a second reference point in the second reference guide image L2_ref. In addition, the ground inclination estimator 111 may estimate a lateral ground inclination A2 based on a difference value between the first displacement difference and the second displacement difference.

Here, each of the first and second displacement differences L1_dif and L2_dif may be a vector value. In this case, the longitudinal ground inclination A1 may be estimated based on an average vector value of the first and second displacement differences L1_dif and L2_dif, and the lateral ground inclination A2 may be estimated based on a difference-of-vectors value of the first and second displacement differences L1_dif and L2_dif, but the present disclosure is not limited thereto.

In some embodiments, the parking assistance apparatus 100 may further include a guide lamp controller 120. Alternatively, the guide lamp controller 120 may be embedded within the guide lamp 10, or may be implemented through a specific control module within the vehicle.

The guide lamp controller 120 may turn on or off the guide lamp 10, control brightness of the guide lamp 10, or change a guide image shape of the guide lamp 10, in consideration of various driving environments such as whether a reverse gear is engaged, ambient brightness around the vehicle, and proximity of a following vehicle.

Meanwhile, the guide lamp 10 is configured to project the guide image L onto the ground surface behind the vehicle. When the vehicle is reversing, the guide lamp irradiates light onto the ground surface behind the vehicle to display the guide image L in a preset shape.

The guide lamp 10 may include a light source composed of an LED and/or a laser beam configured to irradiate light in order to project the guide image L.

The guide image L may be a pair of left and right guide lines formed in a dotted-line shape as illustrated, but the guide image L may alternatively be displayed in various shapes, such as a grid pattern, a cross, a straight line, a curved line, a rhombus, or a honeycomb pattern.

The camera 20 is configured to capture the rear image G of the vehicle, and acquires the rear image by capturing a rear area of the vehicle and the guide image L displayed on the ground surface by the guide lamp 10.

The camera 20 may be provided as a rear camera pre-installed in the vehicle or as a separately installed in-vehicle black box.

The camera 20 transmits the rear image G to the display 30 so that the rear image G is displayed on a screen of the display 30. At this time, when an obstacle is present in the rear image, the obstacle may be targeted and displayed on a user interface using object recognition technology, or a distance between the obstacle and the vehicle may be displayed.

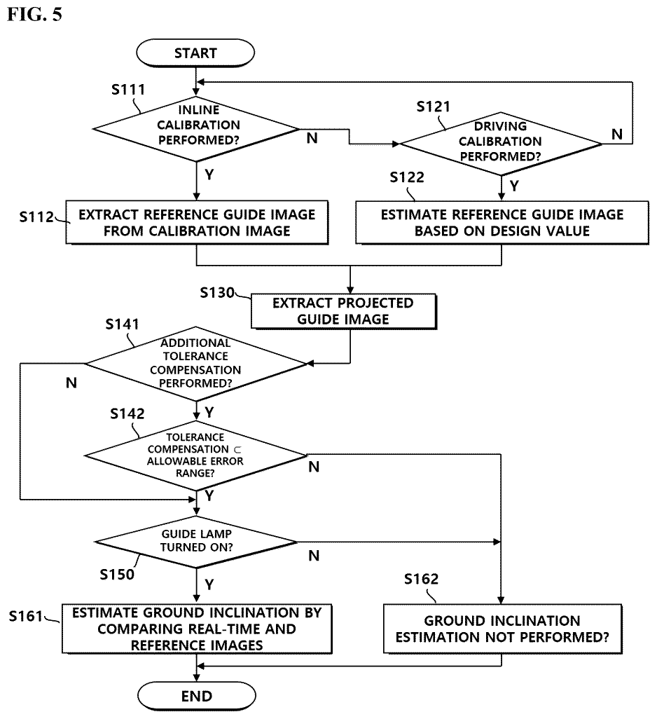

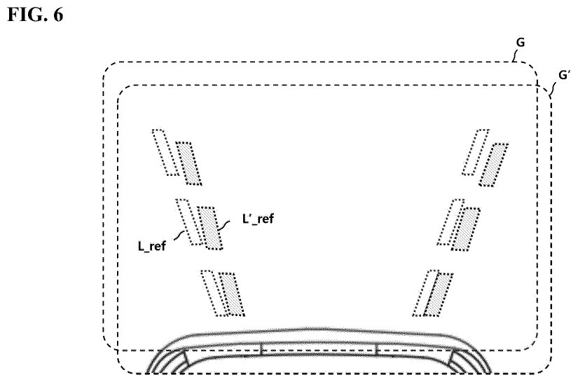

FIG. 5 is an exemplary flowchart for explaining the ground inclination estimation method according to some embodiments of the present disclosure, and FIG. 6 is an exemplary diagram for explaining the guide image captured by the rear camera after additional tolerance compensation according to some embodiments of the present disclosure.

By performing error correction on a distance to an obstacle calculated in a vision-based manner based on the ground inclination estimated through the ground inclination estimation method described below, accuracy of the parking assistance system can be further improved.

Referring to FIGS. 5 to 6, the ground inclination estimation method of the present disclosure estimates the ground inclination behind the vehicle based on the rear image G captured to include the real-time guide image L projected onto the ground surface behind the vehicle by the guide lamp installed at the rear of the vehicle.

Specifically, the ground inclination estimation method of the present disclosure may be performed by extracting data related to the real-time guide image L from the rear image G in step S130, and comparing the data related to the real-time guide image L with data related to the reference guide image L_ref in step S161.

Meanwhile, at least one of the parking assistance apparatus 100, the guide lamp 10, and the camera 20 of the present disclosure may not be included during a vehicle production stage, but may be implemented in the form of modular hardware or software and installed in the vehicle separately at a later time. That is, the parking assistance apparatus 100 may be installed in a vehicle for which EOL calibration has not been performed. In consideration of various vehicle installation environments, the ground inclination estimation method of the present disclosure may further include, as illustrated in FIG. 5, a step of determining whether calibration has been performed for the rear camera of the vehicle in steps S111 and S121. When the calibration has not been performed, the inclination estimation and the obstacle distance error correction may not be performed. This is because sufficient reliability of the guide image extracted from the rear image may not be ensured, and correcting a distance to an obstacle that is directly related to driving safety based on low reliability may increase a probability of an accident.

Meanwhile, the calibration may refer to inline calibration performed in a stopped state of the vehicle using a separate installation pattern on a flat ground surface prepared for the inline calibration, or driving calibration performed during a driving process of the vehicle using feature points on a ground surface behind the vehicle captured by the rear camera of the vehicle.

Meanwhile, the reference guide image L_ref illustrated in FIGS. 2 to 4 may be generated differently depending on a type of calibration.

In some embodiments, when the inline calibration is performed, the reference guide image L_ref may be extracted from an image acquired during the inline calibration.

In other embodiments, when the driving calibration is performed, the reference guide image L_ref may be estimated based on design values of the guide lamp and the rear camera of the vehicle.

Meanwhile, an imaging area of the rear image G may be changed due to various environmental factors occurring during operation of the vehicle, such as component failure, repair of the camera or exterior parts of the vehicle on which the camera is mounted due to an accident, or deviation of a camera installation angle caused by an impact. Thus, additional tolerance compensation may be performed on the camera 10 periodically, aperiodically, or under separate control by an operator.

When additional tolerance compensation is performed, a size, an angle, and/or a position of a guide image L′_ref within an image G′ may be changed. Accordingly, the ground inclination estimation method of the present disclosure may determine whether the additional tolerance compensation has been performed after the reference guide image L_ref has been extracted or estimated in step S141, determine whether a value of the additional tolerance compensation falls within a preset error range in step S142 when the additional tolerance compensation has been performed, and may not perform a step S161 of comparing data related to the real-time guide image L with data related to the reference guide image when the value of the additional tolerance compensation does not fall within the preset error range. This is because sufficient reliability of the guide image extracted from the rear image may not be ensured, and performing error correction on a distance to the obstacle that is directly related to driving safety based on low reliability may increase a probability of an accident.

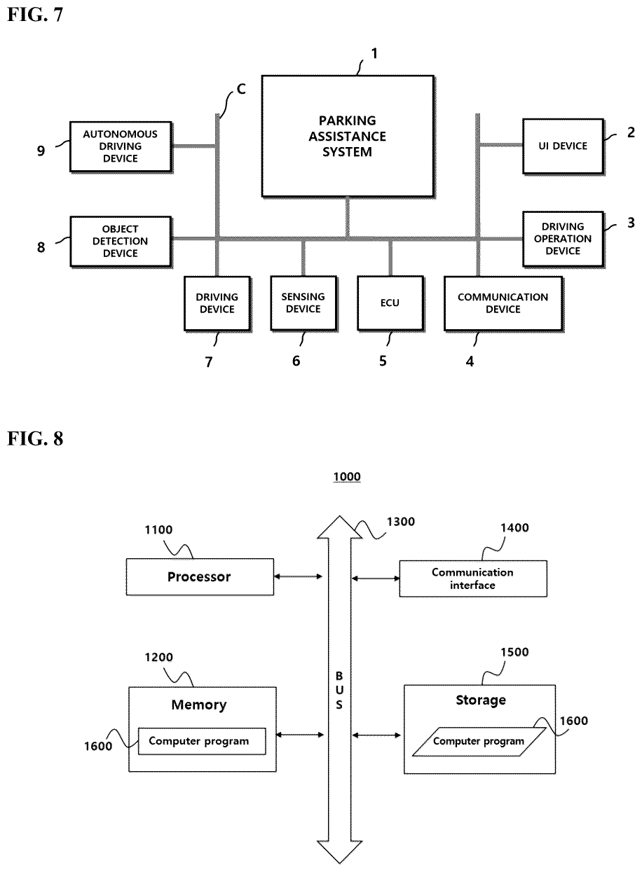

FIG. 7 is an exemplary configuration diagram of a vehicle to which a parking assistance system 1 according to some embodiments of the present disclosure is applied. Referring to FIG. 7, the vehicle to which the parking assistance system 1 is applied may include a UI device 2, a driving operation device 3, a communication device 4, an ECU 5, a sensing device 6, a driving device 7, an object detection device 8, and an autonomous driving device 9.

The UI device 2 is a device for communication between the vehicle and a user, and may receive input from the user or provide information generated by the vehicle to the user.

The driving operation device 3 may include a steering input device, an acceleration input device, and a brake input device.

The communication device 4 may be a device for performing wired and/or wireless communication with devices located inside or outside the vehicle, such as a user smartphone, external infrastructure including a server or a broadcasting station, and other vehicles.

The ECU 5 may control overall operations of at least one electronic device provided in the vehicle.

The sensing device 6 may include an IMU sensor, a collision sensor, a wheel sensor, a speed sensor, an inclination sensor, a weight detection sensor, an ultrasonic sensor, an illuminance sensor, and a pedal position sensor.

The driving device 7 may include devices for electrically controlling various devices in the vehicle, such as a powertrain and a lamp.

The object detection device 8 may be a device for detecting presence or absence, a position, a distance to the vehicle, and a relative speed of an object outside the vehicle. The object detection device 8 may include at least one of a camera, radar, lidar, an ultrasonic sensor, and an infrared sensor. The object detection device 8 may provide data regarding an object generated based on a sensing signal generated by the sensor to at least one electronic device included in the vehicle.

The autonomous driving device 9 may implement at least one advanced driver assistance system (ADAS) function. The autonomous driving device 9 may implement at least one of an adaptive cruise control system (ACC), an autonomous emergency braking system (AEB), a forward collision warning system (FCW), a lane keeping assist system (LKA), a lane change assist system (LCA), a target following assist system (TFA), a blind spot detection system (BSD), a high beam assist system (HBA), an auto parking system (APS), a pedestrian collision warning system, a traffic sign recognition system (TSR), a traffic sign assist system (TSA), a night vision system (NV), a driver status monitoring system (DSM), and a traffic jam assist system (TJA).

The vehicle may include an internal communication system C. A plurality of electronic devices included in the vehicle may exchange signals via the internal communication system C. The signals may include data. The internal communication system C may use at least one communication protocol, such as CAN, LIN, FlexRay, MOST, or Ethernet.

FIG. 8 is an exemplary configuration diagram illustrating a computing device 1000.

As illustrated in FIG. 8, the computing device 1000 may include one or more processors 1100, a bus 1300, a communication interface 1400, a memory 1200, and storage 1500.

The processor 1100 may perform operations for at least one application or program for executing operations/methods according to embodiments of the present disclosure. The computing device 1000 may include one or more processors.

The memory 1200 may load one or more computer programs 1600 from the storage 1500 in order to execute operations/methods according to embodiments of the present disclosure.

The bus 1300 may provide a communication function between components of the computing device 1000.

Next, the communication interface 1400 may support various types of communication, such as wired and or wireless Internet communication of the computing device 1000.

The storage 1500 may non-transitorily store the one or more computer programs 1600.

The computer program 1600 may include one or more instructions that cause the processor 1100 to perform operations/methods according to various embodiments of the present disclosure when the computer program 1600 is loaded into the memory 1200. That is, the processor 1100 may perform operations/methods according to various embodiments of the present disclosure by executing the one or more instructions.

The technical idea of the present disclosure described above with reference to FIGS. 1 to 8 may be implemented as computer-readable code on a computer-readable recording medium.

Although all of the components constituting the embodiment of the present disclosure have been described as being combined or operating in combination, the technical spirit of the present disclosure is not necessarily limited to such embodiment. That is, within the scope and purpose of the present disclosure, the components may selectively operate in combination with one or more of the other components.

Although the operations are illustrated in a specific order in the drawings, it should not be understood that the operations must be performed in the depicted order or in a sequential order, nor should it be understood that all of the illustrated operations must be performed to achieve a desired result. In certain situations, multitasking and parallel processing may be advantageous. Moreover, the separation of various components in the embodiments described above should not be understood as being necessary, and it should be appreciated that the described program components and systems may generally be integrated together into a single software product or packaged as multiple software products.

Although the embodiments of the present disclosure have been described above with reference to the accompanying drawings, those skilled in the art to which the present disclosure pertains will understand that the present disclosure may be implemented in other specific forms without departing from the technical spirit or essential characteristics thereof. Accordingly, the embodiments described above are to be considered in all respects as illustrative and not restrictive. The scope of the present disclosure should be construed in accordance with the appended claims, and all technical ideas falling within the equivalent scope thereof should be interpreted as being included in the scope of the present disclosure.

1. A parking assistance apparatus, comprising:
a ground inclination estimator configured to estimate a ground inclination behind a vehicle; and
an obstacle distance error corrector configured to correct distance information to a rear obstacle of the vehicle according to the estimated ground inclination.

2. The parking assistance apparatus of claim 1, wherein the ground inclination estimator is configured to estimate the ground inclination based on a rear image captured by a rear camera of the vehicle.

3. The parking assistance apparatus of claim 2, wherein the rear image is captured to include a real-time guide image, which is projected onto a ground surface behind the vehicle by a guide lamp installed at a rear of the vehicle.

4. The parking assistance apparatus of claim 3, further comprising:
a projected guide image extractor configured to extract data related to the real-time guide image, from the rear image.

5. The parking assistance apparatus of claim 4, further comprising:
a reference guide image manager configured to generate and manage, as a reference guide image, a guide image projected by the guide lamp onto a flat ground surface that is not inclined with respect to the vehicle.

6. The parking assistance apparatus of claim 5, wherein the ground inclination estimator is configured to estimate the ground inclination by comparing data related to the real-time guide image with data related to the reference guide image.

7. The parking assistance apparatus of claim 6, wherein the ground inclination estimator is configured to estimate the ground inclination based on a displacement difference between a specific real-time point within the real-time guide image and a specific reference point within the reference guide image corresponding to the specific real-time point.

8. The parking assistance apparatus of claim 7, wherein:
the real-time guide image and the reference guide image comprise first and second real-time guide images and first and second reference guide images, respectively, which are spaced apart from each other in a lateral direction of the vehicle, and
the ground inclination estimator is configured to:
estimate a longitudinal ground inclination of the vehicle based on a first displacement difference between a first real-time point in the first real-time guide image and a first reference point in the first reference guide image, and a second displacement difference between a second real-time point in the second real-time guide image and a second reference point in the second reference guide image; and
estimate a lateral ground inclination based on a difference value between the first displacement difference and the second displacement difference.

9. The parking assistance apparatus of claim 8, wherein:
each of the first and second displacement differences is a vector value;
the longitudinal ground inclination is estimated based on an average vector value of the first and second displacement differences; and
the lateral ground inclination is estimated based on a difference vector value of the first and second displacement differences.

10. A parking assistance system, comprising:
a guide lamp configured to project a guide image onto a ground surface behind a vehicle;
a camera configured to acquire an image of an imaging area including the guide image projected by the guide lamp; and
a parking assistance device configured to determine a presence of and a distance to an obstacle located behind the vehicle,
wherein the parking assistance device comprises:
a ground inclination estimator configured to estimate a ground inclination behind the vehicle; and
an obstacle distance error corrector configured to correct distance information to the obstacle located behind the vehicle according to the estimated ground inclination.

11. The parking assistance system according to claim 10, further comprising:
a display configured to display an image acquired in conjunction with the camera.

12. The parking assistance system according to claim 10, further comprising:
a distance sensor implemented by at least one of an ultrasonic proximity sensor, a radar, and a lidar,
wherein the obstacle distance error corrector is configured to correct distance information to the obstacle located behind the vehicle by additionally considering an obstacle recognition distance sensed by the distance sensor.

13. A parking assistance method, comprising:
estimating a ground inclination behind a vehicle based on a rear image captured by a rear camera of the vehicle; and
correcting distance information to a recognized obstacle located behind the vehicle according to the estimated ground inclination.

14. The parking assistance method of claim 13, wherein in the estimating of the inclination, the rear image is captured to include a real-time guide image, which is projected onto a ground surface behind the vehicle by a guide lamp installed at a rear of the vehicle.

15. The parking assistance method of claim 14, wherein the estimating of the inclination comprises:
extracting data related to the real-time guide image, from the rear image; and
comparing data of the real-time guide image with data of a reference guide image projected onto a flat ground surface having no inclination.

16. The parking assistance method of claim 15, further comprising:
determining whether calibration of the rear camera of the vehicle has been performed,
wherein, when the calibration has not been performed, neither the estimating of the inclination nor the correcting of the distance information to the obstacle is not performed.

17. The parking assistance method of claim 16, wherein the calibration is: an inline calibration performed in a stopped state of the vehicle using a pattern installed on a ground surface; or a driving calibration performed during driving of the vehicle.

18. The parking assistance method of claim 17, wherein:
the inline calibration is performed using a separate installation pattern on a flat ground surface prepared for the inline calibration, and
the driving calibration is performed using a feature point on a ground surface behind the vehicle captured by the rear camera of the vehicle during driving of the vehicle.

19. The parking assistance method of claim 18, wherein:
when the inline calibration is performed, the reference guide image is extracted from an image of the inline calibration; and
when the driving calibration is performed, the reference guide image is estimated based on design values of the guide lamp and the vehicle rear camera.

20. The parking assistance method of claim 19, further comprising:
determining whether an additional tolerance compensation has been performed after the reference guide image has been extracted or estimated; and
when the additional tolerance compensation has been performed, determining whether a value of the additional tolerance compensation is within a preset error range,
wherein, when the value of the additional tolerance compensation is not within the preset error range, comparing data of the real-time guide image with data of the reference guide image is not performed.
